(19) United States
(12) Patent Application Publication
(10) Pub. No.: US 2017/0012497 A1
(43) Pub. Date: Jan. 12, 2017

(54) Human Hybrid Scalable Power Plant - Human Hybrid Power Source

(71) Applicant: Darren Keith Wright, Emeryville, CA (US)

(72) Inventor: Darren Keith Wright, Emeryville, CA (US)

(21) Appl. No.: 14/228,160

(22) Filed: Mar. 27, 2014

(51) Int. Cl. H02K 7/18; H02K 7/02; H02K 7/116; H02K 7/00

(52) U.S. Cl. CPC H02K 7/1861; H02K 7/003; H02K 7/025; H02K 7/116; H02K 53/00

(57) ABSTRACT

A kinetic energy conversion method that converts kinetic energy input into helical motion kinetic energy applied to an electrical generating device is disclosed. A kinetic energy force is applied to an input shaft. The input shaft drives a planetary gearing system that accelerates the helical motion. The accelerated output of helical motion is applied to a bevel gear that redirects the motion from horizontal to vertical. The vertical helical motion is applied to a horizontal flywheel rotating on a magnetic levitation system. The rotating horizontal flywheel turns a scalable depending on need sized electrical generator producing carbon free electricity.

### CROSS-REFERENCE TO RELATED APPLICATIONS

This application claims priority to U.S. provisional application Ser. No. 61/805,888, filed on Mar. 27, 2013, the entire contents of which is incorporated herein by reference.

### BACKGROUND OF THE INVENTION

1. Field of the Invention

The subject matter disclosed herein relates to a human kinetic energy to electricity conversion device. More specifically, the present invention relates to a system adapted to convert human kinetic energy to helical kinetic energy. Specifically, a preferred embodiment of the present invention converts human and or natural kinetic energy into helical kinetic energy to turn an electrical generator.

2. Related Discussion

Historically converting human kinetic energy into useful purposes that make quality of life better for said humans has been documented using levers, pulleys, and wheels dating back thousands of years. As has been clearly and historically documented human-powered devices have been driven by forces applied from either an arm/hand or a leg/foot. Historically Kinetic Energy has been supplied from a user's upper torso including the shoulders, arms, and hands, for example, using a rowing motion or by applying kinetic force turning a handled or by pulling and pushing a lever back-and-forth. Kinetic Energy has also been traditionally applied from a user's lower body including the legs and feet through a rotational pedaling motion or by pressing and releasing a set of foot pedals.

Historically humans have used various naturally occurring kinetic energy collection and conversion machines to power machines that improve quality of life and reduce human labor such as windmills and water paddles. These are just two examples that humans have used that harnessed and converted kinetic energy by applying natural forces to rotational mechanisms to supply the drive needed to operate the associated output, be it grinding grain or producing electricity.

The invention discussed here was developed after studying the historical use and uses of productive human kinetic energy as well as the historical productive use of natural kinetic energy. This invention addresses improving upon historic human kinetic energy use specifically as it relates to hybridizing historic and modern windmill electricity generation in terms of advances in kinetic energy capture and conversion into useful purposes such as clean electricity production. As an example, this invention was developed by studying and applying the uses of components found in the traditional Horizontal windmill technology in combination with newer technology found and used in modern Vertical Windmills. The combination of these traditional technologies and the integration of associated modern computer and electronic technologies serves to increase the efficiencies of the invention.

Therefore, a kinetic energy conversion engine which results in a more efficient energy transfer from input to the output would be desirable.

### BACKGROUND

This invention converts human kinetic energy into carbon free clean electricity. This invention solves the problem of human beings needing an external source of electricity to charge batteries and power electrical devices. This invention solves the problem of insufficient human kinetic energy to provide adequate rotational speed to generate electricity using larger electrical generators. This invention solves inefficient and insufficient human kinetic energy capture and conversion to electricity by being “hyper efficient.” i.e. the output is greater than the input. This invention solves the time limitations of the average human's general physical kinetic ability to provide adequate rotational speed and duration to create large amounts of electricity in a short amount of time.

This invention solves limitations of deploying and powering large electrical generators to remote and off grid locations for extended time periods. This invention can be mobile or stationary allowing human beings to generate on demand electricity indefinitely anywhere and anytime 24 hours a day 7 days a week 365 days a year regardless of weather conditions, access to fuel sources, or location. This invention allows a human being to generate enough electricity to power and regulate individual and communal living environments to the standards of a municipal utility powered environment and live 100% independent of connection to local municipal utility grids.

This invention solves the problem of humans needing fossil fuel electrical generators to generate electricity. This invention solves replacing “dirty” energy sources with clean energy sources thereby mitigating greenhouse gas effects. This invention allows a user to quickly “fast” charge batteries that can be used to store the user created electricity to power electrical driven machines and devices as needed on demand.

### BRIEF SUMMARY OF THE INVENTION

This invention converts human kinetic energy into carbon free clean electricity. This invention can be used by human beings to generate on demand clean electrical power on a scalable basis, based upon scale of need. The scale this invention can range from serves individual and multiple household size communal electrical power needs to Katrina, Haiti earthquake, and Typhoon Haiyan scale disaster relief Electrical needs. This invention converts non polluting human kinetic energy into scalable amounts of on demand clean electricity. This invention produces clean electrical energy that reduces the need for carbon based fuels, thereby its use contributes to cleaning the Earth's environment.

This invention has a universal input connection that can utilize multiple different Human and Natural kinetic energy input devices allowing for flexibility and choice in regards to individual physical needs or limitations. A human being can use this invention to provide on demand carbon free clean electrical power to anything and everything that requires electricity to operate.

### DESCRIPTION OF THE DRAWINGS

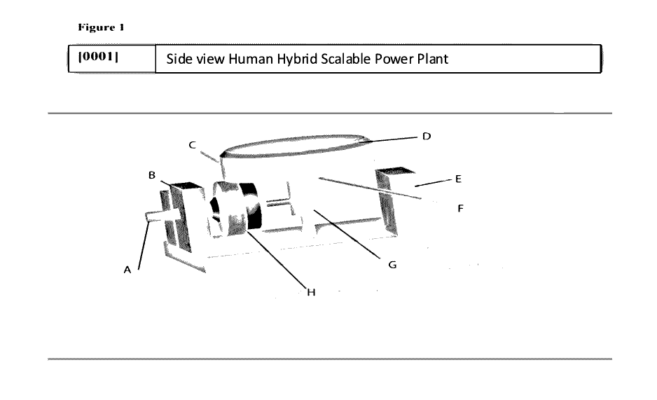

FIG. 1. FIG. 1 shows—Side view of Kinetic energy conversion engine
a. Universal connect input
b. Regenerative Brake
c. Flywheel
d. Generator
e. Power Management Module
f. Magnetic Levitation System
g. Helical Bevel 90 degree thrust drive
h. Helical Planetary Gear transmission

### DETAILED DESCRIPTION AND BEST MODE OF IMPLEMENTATION

This invention converts kinetic energy into scalable amounts of “on demand” clean electricity that can be used for powering or charging any electrical storage and or electrically operated device. This invention has the flexibility to use multiple kinetic energy input modules to supply helical kinetic energy to the kinetic energy transfer, accelerator and conversion engine. This invention has the flexibility to utilize multiple interchangeable kinetic energy generation modules as kinetic energy input devices. Examples of these kinetic energy input devices are a rowing machine, a pedal bike, a leg push, a hand crank, a wind mill, and a water paddle designed to be interchangeable connecting devices to the kinetic energy accelerator and conversion engine's universal input. A kinetic energy input module is connected to the main input shaft of the kinetic energy transfer, accelerator and conversion engine via a bolt and sleeve quick change locking universal connector. The kinetic energy input module is used to create a helical rotational motion that is applied to the main input shaft of the kinetic energy transfer, accelerator and conversion engine.

The rotational speed of the main input shaft is controlled by a regenerative braking system that controls and limits the rotational speed applied by the kinetic input module. The regenerative braking system creates electricity that is then added to the overall system electrical output thus increasing the efficiency of the entire system in creating and generating electricity.

The monitoring and regulation of the regenerative braking system is controlled by a solid state programmable power management module. The power management module's proprietary control program is based upon industry power management programming language standards. The Power Management module includes scalable amounts of solid state internal memory storage, an onboard wireless modem that can accept and transmit system data and updates wirelessly and USB connections for physical user system input and output. The power management system monitors and regulates helical motion traveling from the main input shaft into the Helical Planetary Gear Accelerator. The Power Management Module monitors, regulates and records system functions and historical use and electricity generation that can be accessed by the user.

The main shaft sends the helical motion into the Helical Planetary Gear Accelerator where the initial helical rotational speed is increased using the third law of planetary gearing. This rotational speed increase is scalable based upon electrical output need. The invention's “hyper efficiency” output of the Helical Planetary Gear Accelerator represents the increased original initial input helical rotational speed.

The Helical Planetary Gear Accelerator output shaft sends accelerated helical rotational speed traveling onto the input shaft of the helical bevel geared 90 degree thrust gear. The helical bevel geared 90 degree thrust gear changes the direction of the helical rotational thrust 90 degrees from horizontal input to vertical output.

The accelerated vertical rotational helical motion is then applied to drive a one way clutch system that rotates a magnetically levitated horizontal flywheel plate until the speed and stored energy of the flywheel plate is greater than that of the one way clutch, at which point the one way clutch mechanism will release and allow the flywheel plate to free spin based upon stored kinetic energy until greater rotational speed is applied by the one way clutch.

The spinning flywheel plate stores centrifugal rotational energy and rides in a near frictionless state on a rare earth element based magnetic levitation system. The magnetic levitation system provides minimal friction against the stored energy high speed rotation of the flywheel plate thus allowing it to spin longer than the original force applied by the one way clutch. The flywheel magnetic levitation system free spin continues to rotate without constant external kinetic energy input making the overall system hyper efficient in power generation vs. effort. This stored energy “free spin” system allows the system to continue to create electricity even when the external kinetic energy input has stopped.

The rotating flywheel plate turns an upgradable, interchangeable, and scalable (depending on application) permanent magnet or other electrical generator that creates a scalable amount of clean electricity output that can be applied to any device that accepts electrical storage or uses electricity as its power source to function.

The clean electricity output by the invention is monitored by the power management module which records the amount and frequency of power generated by the invention. The clean electricity output then is fed to a user controlled switch that directs the electrical output to an internal or external mounted fast charge module and/or to an internal or external mounted power inverter. When fed to a fast charge module, the electricity created charges batteries and other energy storage devices. The power management module monitors the amount of electricity in the storage device and regulates the amount and frequency of the charge to mitigate over charging and other safety issues.

When fed through an inverter the electricity is directed into an electrical Smart Grid power panel that distributes electricity to multiple user defined points.

The casing that contains the above system is weather and shock resistant and designed to endure harsh climate related pressures for consistent use in disaster areas and remote/wilderness areas.

### PATENT CITATIONS

U.S. Pat. No. 1,970,729 A
U.S. Pat. No. 1,436,938 A
U.S. Pat. No. 3,233,950 A
U.S. Pat. No. 4,353,569 A
U.S. Pat. No. 4,779,485 A
U.S. Pat. No. 4,329,889 A

1. The invention receives an external kinetic energy input through a universal connection methodology then converts that input into electrical energy. The device uses helical planetary gearing to accelerate horizontal kinetic energy input then transfers the horizontal helical motion of the kinetic energy traveling through the invention vertically through a 90 degree bevel gear. The 90 degree bevel gear applies the vertical helical rotation to a one way clutch controlled horizontal flywheel rotating on a magnetic levitation system. The one way clutch releases the horizontal flywheel when it reaches a speed superior to the applied force of the 90 degree bevel gear. The horizontal flywheel is connected to a scalable electrical generator that rotates based upon the force applied by the horizontal flywheel thereby generating a scalable electrical output.

2. The invention referred to in claim 1. Has an internal monitoring power management system that controls all aspects of the energy that travels into, through and out of the invention.

3. The invention referred to in claim 1. Can be mobile or fixed in place

4. The invention referred to in claim 1. Can interchange at will and has the flexibility to utilize multiple kinetic energy input devices connected to its universal kinetic energy input connector.

5. The invention referred to in claim 1 can interchange and utilize different scalable in size and output electrical generators to achieve the user defined, desired or needed electrical output.

6. The invention referred to in claim 1 can be used to power off grid or hybrid grid urban, rural, and remote rural environmental systems.

7. The invention referred to in claim 1 can be scaled to provide utility scale electrical needs to a scalable population of users.

8. The invention referred to in claim 1 can be used to charge and fast charge external power storage devices for on demand use. This is including but not exclusively applied to residences and vehicles as the source of power in completely or hybridized off grid environmental systems.

9. The invention referred to in claim 1 can be deployed and used for disaster and humanitarian relief
